(19) United States
(12) Patent Application Publication
(10) Pub. No.: US 2005/0165988 A1
(43) Pub. Date: Jul. 28, 2005

(54) Bus communication system

(75) Inventors: Akihiro Kajimura, Kyoto-shi (JP); Akihisa Yamada, Yoshino-gun (JP); Kazuhisa Okada, Ikoma-gun (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka (JP)

(21) Appl. No.: 11/020,124

(22) Filed: Dec. 27, 2004

(30) Foreign Application Priority Data
Dec. 26, 2003 (JP) 2003-435840

(51) Int. Cl. G06F 13/00

(52) U.S. Cl. 710/113

(57) ABSTRACT

A bus communication system for enabling data transfer in synchronized communication is provided, which comprises master circuits, a slave circuit, a bus, and a bus arbitration circuit. Data transfer is performed between the master circuits and the slave circuit via the bus. When a transfer request is output from the master circuits, the right to occupy the bus is given to the master circuit which continuously outputs the transfer request to the same address, not more than a predetermined number of times continuously. When receiving the transfer request from the master circuit, the slave circuit informs the master circuit of the end of bus transfer and whether or not data transfer is ready. When informed that data transfer is ready, the master circuit ends data transfer, and when informed that data transfer is not ready, the master circuit outputs a transfer request to the slave circuit again.

This nonprovisional application claims priority under 35 U.S.C. §119(a) on Patent Application No. 2003-435840 filed in Japan on Dec. 26, 2003, the entire contents of which are hereby incorporated by reference.

### BACKGROUND OF THE INVENTION

1. Field of the Invention

The present invention relates to a bus communication system for transferring data among a plurality of circuits via a bus in synchronized communication.

2. Description of the Related Art

A synchronization channel communication method using a synchronized communication path (synchronization channel) is a method for sending/receiving (transferring) data among a plurality of circuits in synchronized communication. The method is disclosed in, for example, Japanese Laid-Open Publication No. 10-116302, which is directed to a method for efficiently designing an integrated circuit capable of parallel processing or synchronized communication and an integrated circuit designed by the method. In this case, synchronized communication refers to communication in which data transfer is allowed only-after both a data sender and a data receiver are ready to perform data transfer.

Hereinafter, the synchronization channel communication method disclosed in Japanese Laid-Open Publication No. 10-116302 will be described with reference to FIGS. 11 to 14.

FIG. 11 is a block diagram showing a structure of a conventional communication system using a synchronization channel.

As shown in FIG. 11, the conventional communication system comprises circuits 1 to 5, each of which has an operator, such as adder, a multiplier or the like, a comparator or the like to perform a process in accordance with a predetermined procedure. In FIG. 11, letters A, B, C, D, E and F indicate synchronization channels for use in synchronized communication.

The circuit 1 is connected to the circuit 2 via the synchronization channels A and B and to circuit 3 via the synchronization channel C. The circuit 3 is connected to the circuit 4 via the synchronization channel D. The circuit 2 is connected to the circuit 5 via the synchronization channel E. The circuit 5 is connected to the circuit 4 via the synchronization channel F.

FIG. 12 is a block diagram showing an example of a basic structure of a conventional synchronization channel communication system which transfers data a between the circuits 1 and 2 using the synchronization channel A.

Send command and a Receive command are operation descriptions for representing synchronized communication. Send(A, a) indicates sending of synchronizing data a to Receive(A) via a communication path (synchronization channel) A. Receive(A) indicates reception of the synchronizing data a from Send(A, a) via the communication path A.

An operation description 1 of FIG. 12 indicates that Send(A, a) is executed in the circuit 1, and an operation description 2 indicates that Receive(A) is executed in the circuit 2. A dataA signal in the synchronization channel A is a communication data signal. A txA signal is a signal which indicates that the Send command has been performed. When the txA signal is HIGH, it is indicated that the Send command has been performed. An rxA signal is a signal which indicates that the Receive command has been executed. When the rxA signal is HIGH, it is indicated that the Receive command has been executed.

FIG. 13 is a timing diagram showing an exemplary communication method which is performed in the synchronization channel communication system of FIG. 12. Particularly, it is shown that the synchronizing data sender circuit is ready earlier than the data receiver circuit, and the Send command is executed earlier than the Receive command.

Referring to FIG. 13, when the Send command is executed, at T11 the circuit 1 sends data a, which is included in the dataA signal, and causes the txA signal to go to HIGH, and waits until the rxA signal goes to HIGH. When the Receive command is executed, the circuit 2 causes the rxA signal to go to HIGH at T13.

Next, when confirming that the rxA signal is HIGH, the circuit 1 causes the txA signal to go to LOW at T14. When confirming that the txA signal is HIGH, the circuit 2 receives the data a from the dataA signal, and at T14, causes the rxA signal to go to LOW.

FIG. 14 is a timing diagram showing an exemplary communication method which is performed in the synchronization channel communication system of FIG. 12. Particularly, it is shown that the circuit of the synchronizing data receiver has been ready earlier than the circuit of the data sender, and the Receive command is executed earlier than the Send command.

Referring to FIG. 14, when the Receive command is executed, at T21 the circuit 2 causes the rxA signal to go to HIGH and waits until the txA signal goes to HIGH. When the Send command is executed, the circuit 1 sends data a, which is included in the dataA signal, and causes the txA signal to go to HIGH at T23.

Next, when confirming that the txA signal is HIGH, the circuit 2 receives the data a from the dataA signal and at T24 causes the rxA signal to go to LOW. When confirming that the rxA signal is HIGH, the circuit 1 causes the txA signal to go to LOW at T24.

When the Send command and the Receive command have been executed simultaneously in FIG. 12, the txA signal and the rxA signal go to HIGH simultaneously. In the next cycle, both the txA signal and the rxA signal go to LOW.

As another method for transfer data among a plurality of circuits via synchronized communication, a bus communication method is used in which a bus is provided between each circuit which performs communication.

The bus communication method employing a bus will be described with reference to FIGS. 15 to 21.

FIG. 15 is a block diagram showing a structure of a conventional bus communication system employing a bus.

Referring to FIG. 15, the conventional bus communication system comprises circuit 1 to 5, each of which has an operator, such as adder, a multiplier or the like, a comparator or the like to perform a process in accordance with a predetermined procedure. The conventional bus communication system further comprises bus interfaces 51a to 55a for communication via a common bus to which the circuits 1 to 5 are connected. The bus interfaces 51a to 55a control data write/read operations in accordance with a bus protocol. In this case, an interface which sends a write/read request to the common bus is referred to as a master interface, while an interface which responds to a write/read request from the common bus is referred to as a slave interface. Also in the system, a circuit having a master interface is referred to as a master circuit, while a circuit having a slave interface is referred to as a slave circuit.

In the bus communication system, a master circuit occupies one bus for a predetermined period of time so data transfer is performed between the master circuit and a slave circuit. The bus communication system further comprises a bus arbitration circuit 56 which permits bus transfer for one master circuit. When a plurality of master circuits request use of a bus simultaneously, the bus arbitration circuit 56 determines to which master circuit the right to occupy the bus is given. Note that no bus arbitration circuit 56 may be provided when only one circuit is operated as a master circuit in the system.

Also in FIG. 15, letters A, B, C, D, E and F indicate synchronization ports for synchronized communication. The synchronization port actually means an address which is assigned to an address space of the common bus. The synchronization port is used by a master circuit to designate a communication destination, and therefore, is assigned to a bus interface of a slave circuit.

A circuit 51 shown in FIG. 15 is a master circuit, while circuits 52 to 55 are slave circuits. In the slave circuit 52, addresses A and B are assigned to a slave interface (bus interface) 52a. In the slave circuit 53, addresses C and D are assigned to a slave interface 53a. In the slave circuit 54, an address F is assigned to a slave interface 54a. In the slave circuit 55, an address E is assigned to a slave interface 55a.

FIG. 16 is a block diagram showing an example of a basic structure of a conventional bus communication system in which a circuit executing the Send command is a master circuit.

Referring to FIG. 16, an operation description 1 describes an operation of the circuit 1 such that Send(A, a) is executed in the circuit 1. An operation description 2 describes an operation of a circuit 2 such that Receive(A) is executed in the circuit 2. A wdataA signal and an rdataA signal are communication data signals. A wtxA signal and an rtxA signal are signals which indicate that the Send command has been executed, when the signal is HIGH. A wrxA signal and an rrxA signal are signals which indicate that the Receive command has been executed, when the signal is HIGH.

A common bus signal is composed of a BUSaddr signal, a BUSwdata signal, a BUSwen signal, and a BUSack signal. The BUSaddr signal is a signal for designating an address. The BUSwdata signal is a write data signal. The BUSwen signal is a write request signal which indicates that a write request is output, when the signal is HIGH. The BUSack signal is a communication end signal which indicates that bus transfer is ended, when the signal is HIGH.

In the bus communication system of FIG. 16, a BUSwdata1 signal and a BUSwdata2 signal are included in the BUSwdata signal on the common bus. A BUSaddr1 signal and a BUSaddr2 signal are included in the BUSaddr signal on the common bus. A BUSwen1 signal and a BUSwen2 signal are included in the BUSwen signal on the common bus. A BUSack1 signal and a BUSack2 signal are included in the BUSack signal on the common bus.

Hereinafter, an operation of the interface section will be described, where the method of FIG. 13 is used for communication between the circuit 1 and a master interface 1, while the method of FIG. 14 is used for communication between the circuit 2 and a slave interface 2.

The wdataA signal and the rdataA signal correspond to the dataA of FIGS. 13 and 14. The wtxA signal and the rtxA signal correspond to the txA signal of FIGS. 13 and 14. The wrxA signal and the rrxA signal correspond to the rxA signal of FIGS. 13 and 14.

FIG. 17 is a timing diagram showing an example of a bus communication method such that, in the bus communication system of FIG. 16, the synchronizing data sender circuit is ready earlier than the receiver circuit, and the Send command is executed earlier than the Receive command. Note that the initial values of the BUSwen signal, the BUSack signal, the wtxA signal, the wrxA signal, the rtxA signal, and the rrxA signal are at a LOW level after being reset.

Referring to FIG. 17, when the circuit 1 causes the wtxA signal (Send command execution signal) to go to HIGH at T31, the master interface 1 determines which synchronization port is requested. At T32, the master interface 1 sends an address A and data a, which are included in the BUSaddr signal and the BUSwdata signal, respectively, on the common bus, and causes the BUSwen signal (write request signal) to go to HIGH, and waits until the BUSack signal (communication end signal) goes to HIGH.

Next, at T33, when the circuit 2 causes the rrxA signal (Receive command execution signal) to go to HIGH, the slave interface 2 confirms that the BUSaddr signal includes the address A and the BUSwen signal is HIGH (write request to the address A). At T34, the slave interface 2 causes the BUSack signal (communication end signal) to be HIGH during one cycle, sends the data a of the BUSwdata signal, which is included in the rdataA signal, and causes the rtxA signal (Send command execution signal) to be HIGH during one cycle.

When the BUSack signal goes to HIGH, the master interface 1 causes the wrxA signal (Receive command execution signal) to be HIGH during one cycle at T34. At T35, the synchronized communication is completed.

FIG. 18 is a timing diagram showing an example of a bus communication method such that, in the bus communication system of FIG. 16, a circuit of the synchronizing data receiver is ready earlier than a circuit of the sender, and the Receive command is executed earlier than the Send command. Note that the initial values of the BUSwen signal, the BUSack signal, the wtxA signal, the wrxA signal, the rtxA signal, and the rrxA signal are at a LOW level after being reset.

Referring to FIG. 18, when the circuit 2 causes the rrxA signal (Receive command execution signal) to go to HIGH at T41, the slave interface 2 waits until a write request to the address A is issued.

Next, when the circuit 1 causes the wtxA signal (Send command execution signal) to go to HIGH at T42, the master interface 1 determines which synchronization port requested. At T43, the master interface 1 sends an address A and data a, which are included in the BUSaddr signal and the BUSwdata signal, respectively, on the common bus, and causes the BUSwen signal (write request signal) to go to HIGH, and waits until the BUSack signal (communication end signal) to go to HIGH.

At T44, the slave interface 2 confirms that the BUSaddr signal includes the address A and the BUSwen signal is HIGH (write request to the address A), causes the BUSack signal (communication end signal) to be HIGH during one cycle, sends the data a of the BUSwdata signal, which is included in the rdataA signal, and causes the rtxA signal (Send command execution signal) to go to HIGH during one cycle. When the BUSack signal (communication end signal) goes to HIGH, the master interface 1 causes the wrxA signal to go to HIGH(Receive command execution signal) during one cycle at T44. At T45, the synchronized communication is completed.

In the synchronized communication example of FIGS. 17 and 18, the master circuit does not necessarily obtain the right to occupy the bus immediately. In such a case, if the wrxA signal is caused to be LOW until the right to occupy the bus is obtained, synchronized communication can be similarly performed.

FIG. 19 is a block diagram showing an example of a basic structure of a conventional bus communication system in which a circuit executing the Receive command is a master circuit.

Referring to FIG. 19, an operation description 1 describes an operation of a circuit 1 such that Receive(A) is executed in the circuit 1. An operation description 2 describes an operation of a circuit 2 such that Send(A, a) is executed in the circuit 2. A wdataA signal and an rdataA signal are communication data signals. A wtxA signal and an rtxA signal are signals which indicate that the Send command has been executed, when the signal is HIGH. A wrxA signal and an rrxA signal are signals which indicate that the Receive command has been executed, when the signal is HIGH.

A common bus signal is composed of a BUSaddr signal, a BUSrdata signal, a BUSren signal, and a BUSack signal. The BUSaddr signal is a signal for designating an address. The BUSrdata signal is a read data signal. The BUSren signal is a read request signal which indicates that a read request is sent, when the signal is HIGH. The BUSack signal is a communication end signal which indicates that bus transfer is completed, when the signal is HIGH.

In the bus communication system of FIG. 19, a BUSrdata1 signal and a BUSrdata2 signal are included in the BUSrdata signal on a common bus. A BUSaddr1 signal and a BUSaddr2 signal are included in the BUSaddr signal on the common bus. A BUSren1 signal and a BUSren2 signal are included in the BUSren signal on the common bus. A BUSack1 signal and a BUSack2 signal are included in the BUSack signal on the common bus.

Hereinafter, an operation of an interface portion will be described, where the method of FIG. 13 is used for communication between the circuit 1 and a master interface 1, and the method of FIG. 14 is used for communication between the circuit 2 and a slave interface 2.

The wdataA signal and the rdataA signal correspond to the dataA of FIGS. 13 and 14. The wtxA signal and the rtxA signal correspond to the txA signal of FIGS. 13 and 14. The wrxA signal and the rrxA signal correspond to the rxA signal of FIGS. 13 and 14.

FIG. 20 is a timing diagram showing an example of a communication method such that, in the bus communication system of FIG. 19, the synchronizing data sender circuit is ready earlier than a circuit of the sender, and the Send command is executed earlier than the Receive command. Note that the intial values of the BUSren signal, the BUSack signal, the wtxA signal, the wrxA signal, the rtxA signal, and the rrxA signal are at a LOW level after being reset.

Referring to FIG. 20, when the circuit 2 causes the wtxA signal (Send command execution signal) to go to HIGH at T51, the slave interface 2 waits until a read request to an address A is issued.

Next, at T52, when the circuit 1 causes the rrxA signal (Receive command execution signal) to go to HIGH, the master interface 1 determines which synchronization port is requested. At T53, the master interface 1 sends the address A, which is included in the BUSaddr signal on the common bus, and causes the BUSren signal (read request signal) to go to HIGH, and waits until the BUSack signal (communication end signal) goes to HIGH.

Further, at T54, the slave interface 2 confirms that the BUSaddr signal includes the address A and the BUSren signal is HIGH (read request to the address A), sends the BUSrdata signal including the data a onto the common bus, causes the BUSack signal (communication end signal) to be HIGH during one cycle, and causes the wrxA signal (Receive command execution signal) to be HIGH during one cycle.

When the BUSack signal goes to HIGH, at T54 the master interface 1 sends the rdataA signal including the data a of the BUSrdata signal, and causes the rtxA signal (Send command execution signal) to be HIGH during one cycle. At T55, the synchronized communication is completed.

FIG. 21 is a timing diagram showing an example of a communication method such that, in the bus communication system of FIG. 19, the synchronizing data receiver circuit is ready earlier than the sender circuit, and the Receive command is executed earlier than the Send command. Note that the initial values of the BUSwen signal, the BUSack signal, the wtxA signal, the wrxA signal, the rtxA signal, and the rrxA signal are at a LOW level after being reset.

Referring to FIG. 21, at T61, when the circuit 1 causes the rrxA signal (Receive command execution signal) to go to HIGH, the master interface 1 determines which synchronization port is requested.

Next, at T62, the master interface 1 sends an address A, which is included in the BUSaddr signal on the common bus, and causes the BUSren signal (read request signal) to go to HIGH, and waits until the BUSack signal (communication end signal) goes to HIGH.

Further, at T63, when the circuit 2 causes the wtxA signal (Send command execution signal) to go to HIGH, the slave interface 2 confirms that the BUSaddr signal includes the address A and the BUSren signal is HIGH (read request to the address A). At T64, the slave interface 2 causes the BUSack signal (communication end signal) to be HIGH during one cycle, sends data a, which is included in the BUSrdata signal on the common bus, and causes the wrxA signal (Receive command execution signal) to be HIGH during one cycle.

When the BUSack signal (communication end signal) goes to HIGH, at T64 the master interface 1 sends the data a of the BUSrdata signal, which is included in the rdataA signal, and causes the rtxA signal (Send command execution signal) to be HIGH during one cycle. At T65, the synchronized communication is completed.

In the synchronized communication example of FIGS. 20 and 21, the master circuit 1 may not obtain the right to occupy the bus immediately. Even in this case, if the rtxA signal is caused to be LOW until the right to occupy the bus is obtained, synchronized communication can be similarly performed.

In the foregoing description, one circuit has one of a master interface and a slave interface. Alternatively, one circuit can have both a master interface and a slave interface.

However, in the above-described conventional synchronization channel communication method, the amount of wiring between circuits grows in proportion to the number of synchronization channels. Therefore, when a number of synchronization channels are used, the amount of wiring between circuits is considerably large, likely leading to an extremely large chip area or an impossible layout.

In the above-described conventional bus communication method, even when a number of synchronization ports are used, the amount of wiring is not increased, as is different from the conventional synchronization channel communication method. However, when a plurality of circuits are connected to a common bus, the following deadlock is likely to occur.

For example, as shown in FIG. 22, in a conventional bus communication system in which a circuit executing the Receive command is a master circuit, a circuit 1 executes Receive(A), a circuit 3 executes Receive(B), and a circuit 2 executes Send(A, a), and thereafter, executes Send(B, b).

In the bus communication system of FIG. 22, the Receive command of the circuit 3 is executed earlier than the circuit 1, and the right to occupy a common bus is given to a master interface 3. Even when a data read request is issued to a synchronization port B, the circuit 2 which is requested for data read does not execute synchronized communication via the synchronization port B if synchronized communication via a synchronization port A is not established, and a response signal cannot be returned.

In this case, the slave interface 2 is waiting for a read request to the synchronization port A. Even when the master interface 1 issues a read request to the synchronization port A, since the master interface 3 occupies the common bus, the bus arbitration circuit 56 cannot give the master interface 1 the right to occupy the common bus. Therefore, the slave interface 2 waits perpetually for the read request to the synchronization port A, so that the common bus is continued to be occupied, i.e., deadlock occurs.

To avoid the deadlock, a bus arbitration circuit having the following mechanism is conceived. When a certain master circuit (master interface) occupies the common bus for a predetermined number of cycles, the connection to the common bus is temporarily cut, and the right to occupy the bus is given to another master circuit. Even in this case, the cycles are wasted until the connection to the common bus is cut.

### SUMMARY OF THE INVENTION

According to an aspect of the present invention, a bus communication system for enabling data transfer in synchronized communication is provided, which comprises a plurality of master circuits, a slave circuit connected to the plurality of master circuits, a bus connected to the plurality of master circuits and the slave circuit, and a bus arbitration circuit connected to the bus. Data transfer is performed between the plurality of master circuits and the slave circuit via the bus. The bus arbitration circuit performs arbitration such that, when a transfer request is output from the plurality of master circuits, a right to occupy the bus is given to the master circuit which continuously outputs the transfer request to the same address, not more than a predetermined number of times continuously. When receiving the transfer request from the master circuit, the slave circuit informs the master circuit of the end of bus transfer and of whether or not data transfer is ready. When informed that data transfer is ready, the master circuit ends data transfer, and when informed that data transfer is not ready, the master circuit outputs a transfer request to the slave circuit again.

In one embodiment of this invention, when the slave circuit receives the transfer request from the master circuit and informs the master circuit that data transfer is not ready, the slave circuit informs the master circuit of the end of bus transfer after waiting for a predetermined number of cycles if data transfer is still not ready, or immediately informs the master circuit of the end of bus transfer and informs that data transfer is ready if data transfer gets ready partway during waiting.

In one embodiment of this invention, when data is written from the master circuit to the slave circuit, the write data is sent from the master circuit and the write data is received by the slave circuit. In the data transfer operation, when the slave circuit receives a data write request as the transfer request from the master circuit, the slave circuit informs the master circuit of the end of bus transfer and of whether or not data write is ready. When informed by the slave circuit that data write is ready, the master circuit ends the data write operation, or when informed by the slave circuit that data write is not ready, the master circuit outputs the data write request to the slave circuit again.

In one embodiment of this invention, when the master circuit performs reading data from the slave circuit, the read data is sent from the slave circuit and the read data is received by the master circuit. In the data transfer operation, when the slave circuit receives a data read request as the transfer request from the master circuit, the slave circuit informs the master circuit of the end of bus transfer and of whether or not data read is ready. When informed by the slave circuit that data read is ready, the master circuit ends the data read operation, or when informed by the slave circuit that data read is not ready, the master circuit outputs the data read request to the slave circuit again.

In one embodiment of this invention, when the plurality of master circuits output a transfer request, the bus arbitration circuit assigns priorities to the plurality of master circuits and gives the plurality of master circuits the right to occupy the bus in order of the priority, highest first. The bus arbitration circuit performs arbitration in a manner such that when the right to occupy the bus is given to the master circuit having a high priority which is accessing the same address, the predetermined number of times continuously, the priority of the master circuit continuously given the right to occupy the bus is temporarily lowered, and another master circuit is given the right to occupy the bus.

In one embodiment of this invention, when the plurality of master circuits output a transfer request, the bus arbitration circuit assigns priorities to the plurality of master circuits and gives the plurality of master circuits the right to occupy the bus in order of the priority, highest first. The bus arbitration circuit performs arbitration in a manner such that when the right to occupy the bus is given to the master circuit having a high priority which is accessing the same address, the predetermined number of times continuously, the right to occupy the bus is given to the master circuit at random irrespective of the priorities.

In one embodiment of this invention, the master circuit has an internal arbitration circuit, wherein the internal arbitration circuit performs arbitration in a manner such that when a plurality of data transfer requests to the bus are simultaneously issued, the same data transfer request is prevented from being continued more than the predetermined number of times.

In one embodiment of this invention, when the plurality of master circuits output a transfer request, the internal arbitration circuit assigns priorities to the plurality of master circuits and gives the plurality of master circuits the right to occupy the bus in order of the priority, highest first. The internal arbitration circuit performs arbitration in a manner such that when the right to occupy the bus is given to the master circuit having a high priority which is accessing the same address, the predetermined number of times continuously, the priority of the master circuit continuously given the right to occupy the bus is temporarily lowered, and another master circuit is given the right to occupy the bus.

In one embodiment of this invention, when the plurality of master circuits output a transfer request, the internal arbitration circuit assigns priorities to the plurality of master circuits and gives the plurality of master circuits the right to occupy the bus in order of the priority, highest first. The internal arbitration circuit performs arbitration in a manner such that when the right to occupy the bus is given to the master circuit having a high priority which is accessing the same address, the predetermined number of times continuously, the right to occupy the bus is given to the master circuits at random irrespective of the priorities.

Functions of the above-described arrangements of the present invention will be described.

According to the present invention, in a bus communication system (bus communication apparatus) which performs data transfer between a master circuit and a slave circuit via a bus in synchronized communication, when a plurality of master circuits output a transfer request, the slave circuit informs whether or not bus communication (bus transfer) is ended (bus transfer end information), and also informs whether or not the slave circuit is ready to do data transfer. When data transfer is ready, the master circuit ends data transfer. When data transfer is not ready, the master circuit outputs a data transfer request again.

When the slave circuit receives the transfer request from the master circuit, the common bus is temporarily released if the slave circuit is not ready to do data transfer. In this case, the bus arbitration circuit does not give the right to occupy to the master circuit accessing the same address which outputs the transfer request a predetermined number of times n or more (integer of 0 or more), and can give another master circuit the right to occupy the bus. Therefore, deadlock which otherwise occurs in conventional technology can be prevented, thereby making it possible to use the bus more effectively.

For example, the bus arbitration circuit assigns priorities to the plurality of master circuits and gives the plurality of master circuits the right to occupy the bus in order of the priority, highest first. When the right to occupy the bus is given to the master circuit having a high priority which is accessing the same address, a predetermined number of times m (integer of 1 or more) continuously, the priority of the master circuit is temporarily lowered so that another master circuit is given the right to occupy the bus, or alternatively, another master circuit is randomly selected to be given the right to occupy the bus.

Each master circuit is provided with an internal arbitration circuit which performs arbitration in a manner such that when a plurality of data transfer requests to the bus are simultaneously output from one master circuit, the same data transfer request is prevented from being continued more than a predetermined number of times m (integer of 1 or more).

The internal arbitration circuit assigns priorities to the plurality of master circuits and gives the plurality of master circuits the right to occupy the bus in order of the priority, highest first. When the right to occupy the bus is given to the master circuit having a high priority which is accessing the same address, a predetermined number of times m (integer of 1 or more) continuously, the priority of the master circuit is temporarily lowered so that another master circuit is given the right to occupy the bus, or alternatively, another master circuit is randomly selected to be given the right to occupy the bus.

In the bus communication apparatus of the present invention, for example, a data sender is a master circuit, while a data receiver is a slave circuit. The master circuit and the slave circuit perform data transfer in synchronized communication, e.g., the master circuit writes data into the slave circuit. When the master circuit outputs a write request of synchronized communication data, a designated slave circuit receives data when the slave circuit is ready to receive the synchronized communication data, and informs the end of bus transfer using a communication end signal to immediately end bus communication. When the slave circuit is not ready to receive data, the slave circuit may wait form cycles, and after that, may end communication. When the slave circuit gets ready partway during the n cycles, the slave circuit receives data and immediately ends bus communication. When n is zero, the slave circuit ends bus communication immediately without waiting.

To inform the end of bus transfer, the slave circuit uses a transfer completion signal to inform the master circuit whether or not the slave circuit has received the synchronized communication data. When the slave circuit is ready to receive data, the slave data receives the data and informs that data reception is completed. When the slave circuit is not ready to receive data, the slave circuit informs that the slave circuit is not ready to receive data.

When the master circuit is informed of the end of bus transfer, the master circuit determines, based on the transfer completion signal, whether or not to do data transfer again. When the data transfer request is completed, at that time point the master circuit ends synchronized communication. When the data transfer request is not completed, the data transfer request of synchronized communication is repeated.

In this case, when another master circuit outputs a data transfer request, the bus arbitration circuit gives the other master circuit the right to occupy the bus, thereby making it possible to effectively utilize the bus to avoid deadlock.

Next, a data receiver is a master circuit, while a data sender is a slave circuit. The master circuit and the slave circuit can do data transfer in synchronized communication, e.g., the master circuit reads data from the slave circuit.

In this case, when the master circuit outputs a read request of synchronized communication data, and a designated slave circuit sends data when the slave circuit is ready to send the synchronized communication data, informs the end of bus transfer using a communication end signal to immediately end bus communication. When the slave circuit is not ready to receive data, the slave circuit may wait form cycles, and after that, may end communication. When the slave circuit gets ready partway during the n cycles, the slave circuit sends data and immediately ends bus communication. When n is zero, the slave circuit ends bus communication immediately without waiting.

To inform the end of bus transfer, the slave circuit uses a transfer completion signal to inform the master circuit of whether or not the slave circuit has sent the synchronized communication data. When the slave circuit is ready to send data, the slave circuit sends the data and informs that data sending is completed. When the slave circuit is not ready to send data, the slave circuit informs that the slave circuit is not ready to send data.

When the master circuit is informed of the end of bus transfer, the master circuit determines, based on the transfer completion signal, whether or not to do data transfer again. When the data transfer is completed, at that time point the master circuit ends synchronized communication. When the data transfer is not completed, the data transfer request of synchronized communication is repeated.

In this case, when another master circuit outputs a data transfer request, the bus arbitration circuit gives the other master circuit the right to occupy the bus, thereby making it possible to effectively utilize the bus to avoid deadlock.

According to the present invention, a common bus is provided between circuits performing synchronized communication so that the amount of wiring between circuits can be reduced. The common bus is occupied only as required, by informing the ready state of data transfer or transfer completion. The common bus is not continuously occupied, thereby making it possible to achieve a bus communication system capable of efficient synchronized communication. The present invention can be applied to a wide range of large scale integrated circuits which perform synchronized communication among a plurality of circuits.

Thus, the invention described herein makes possible the advantage of providing a bus communication system capable of efficient synchronized communication, in which the amount of wiring between circuits is small and deadlock can be prevented.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing a structure of a bus communication system according to an embodiment of the present invention.

FIG. 2 is a block diagram showing an example of a basic structure of a bus communication system in which a circuit executing a Send command is a master circuit.

FIG. 3 is a timing diagram showing an example of a bus communication method such that, in the bus communication system of FIG. 2, the synchronizing data sender circuit is ready earlier than the receiver circuit, and the Send command is executed earlier than the Receive command.

FIG. 4 is a block diagram showing an exemplary structure of an arbitration circuit bus which is the same as the arbitration circuit of FIG. 1, except that the arbitration circuit bus employs a method of temporarily lowering the right to occupy the bus.

FIG. 5 is a block diagram showing an exemplary structure of a bus arbitration circuit which is the same as the bus arbitration circuit of FIG. 1, except that the bus arbitration circuit employs a method of giving the right to occupy the bus to a master circuit at random.

FIG. 6 is a timing diagram showing an example of a communication method such that, in the bus communication system of FIG. 2, a synchronizing data receiver circuit is ready earlier than the sender circuit, and the Receive command is executed earlier than the Send command.

FIG. 7 is a block diagram showing a basic structure of a bus communication system which is the same as the bus communication system of FIG. 1, except that a circuit executing the Receive command is a master circuit.

FIG. 8 is a timing diagram showing an example of a bus communication method such that, in the bus communication system of FIG. 7, the synchronizing data sender circuit is ready earlier than the receiver circuit, and the Send command is executed earlier than the Receive command.

FIG. 9 is a timing diagram showing an example of a communication method such that, in the bus communication system of FIG. 7, a synchronizing data receiver circuit is ready earlier than the sender circuit, and the Receive command is executed earlier than the Send command.

FIG. 10 is a block diagram showing a system structure to which a bus communication system of the present invention is applied with respect to a conventional bus communication system structure of FIG. 22 having the problem.

FIG. 11 is a block diagram showing a structure of a conventional communication system using a synchronization channel.

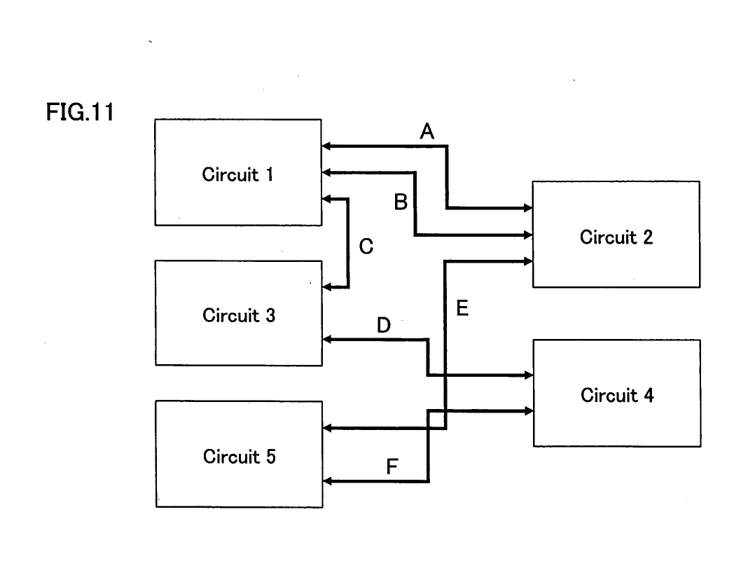

FIG. 12 is a block diagram showing an example of a basic structure of a conventional synchronization channel communication system which transfers data between circuits using a synchronization channel.

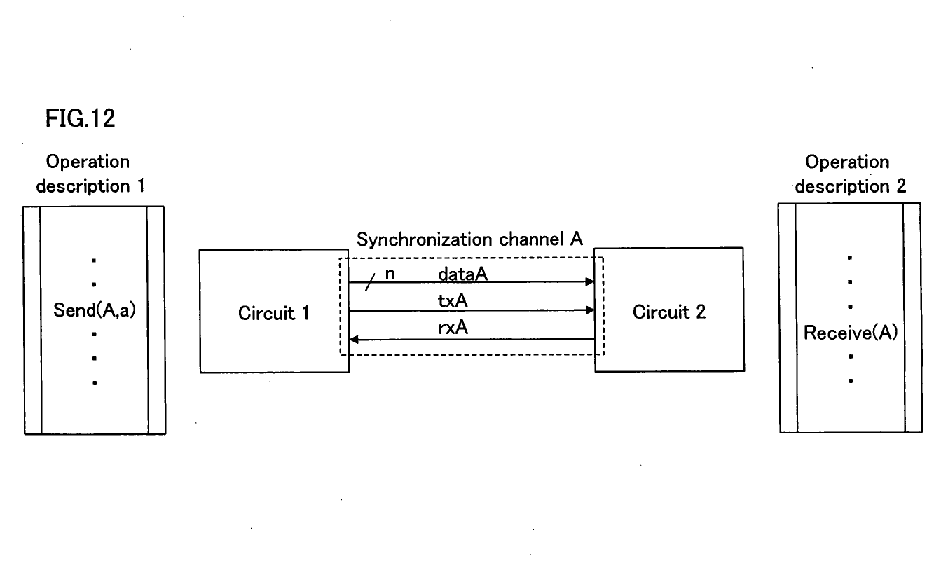

FIG. 13 is a timing diagram showing an exemplary communication method such that, in the synchronization channel communication system of FIG. 12, the synchronizing data sender circuit is ready earlier than the data receiver circuit, and the Send command is executed earlier than the Receive command.

FIG. 14 is a timing diagram showing an exemplary communication method such that, in the synchronization channel communication system of FIG. 12, the circuit of the synchronizing data receiver has been ready earlier than the circuit of the data sender, and the Receive command is executed earlier than the Send command.

FIG. 15 is a block diagram showing a structure of a conventional bus communication system employing a bus.

FIG. 16 is a block diagram showing an example of a basic structure of a conventional bus communication system in which a circuit executing the Send command is a master circuit.

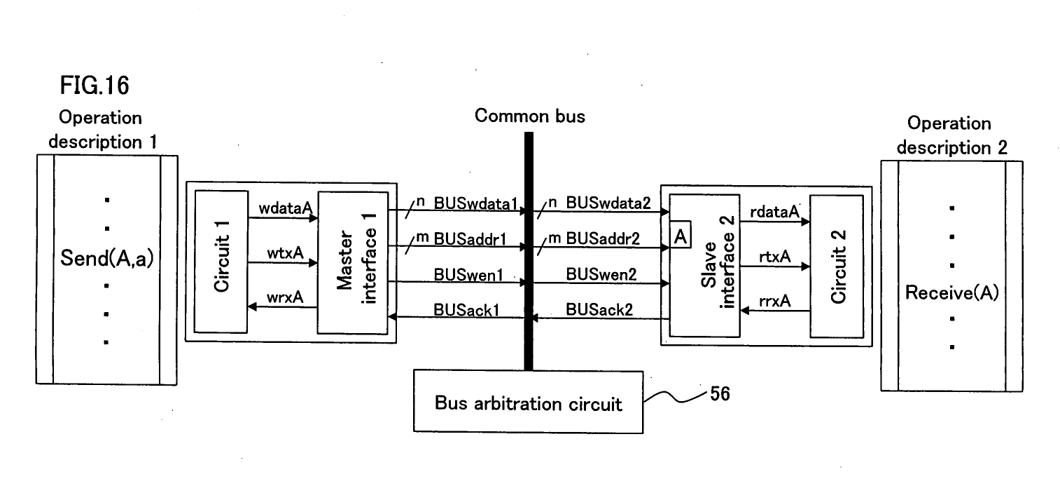

FIG. 17 is a timing diagram showing an example of a bus communication method such that, in the bus communication system of FIG. 16, the synchronizing data sender circuit is ready earlier than the receiver circuit, and the Send command is executed earlier than the Receive command.

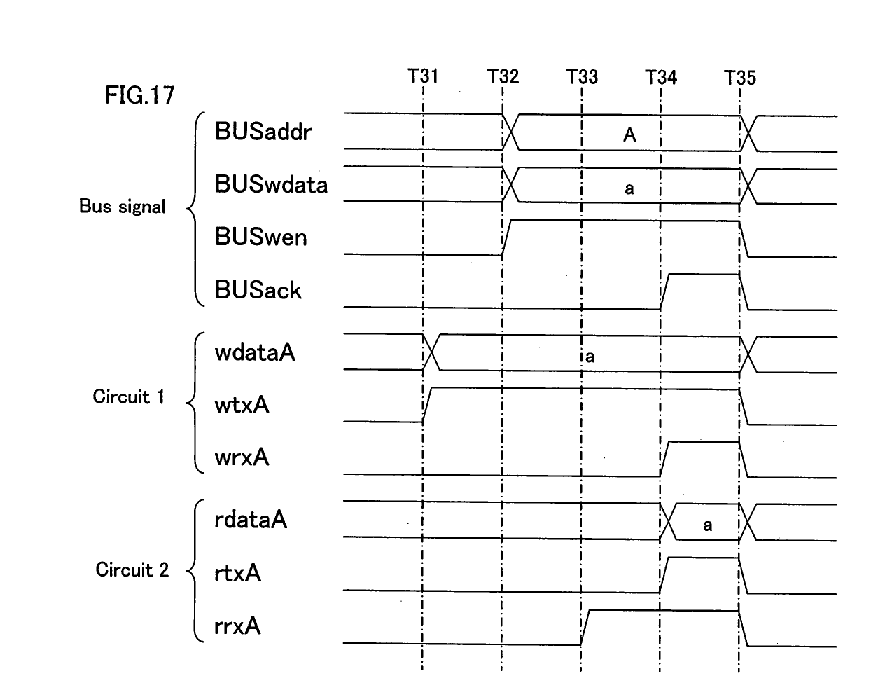

FIG. 18 is a timing diagram showing an example of a bus communication method such that, in the bus communication system of FIG. 16, a circuit of the synchronizing data receiver is ready earlier than a circuit of the sender, and the Receive command is executed earlier than the Send command.

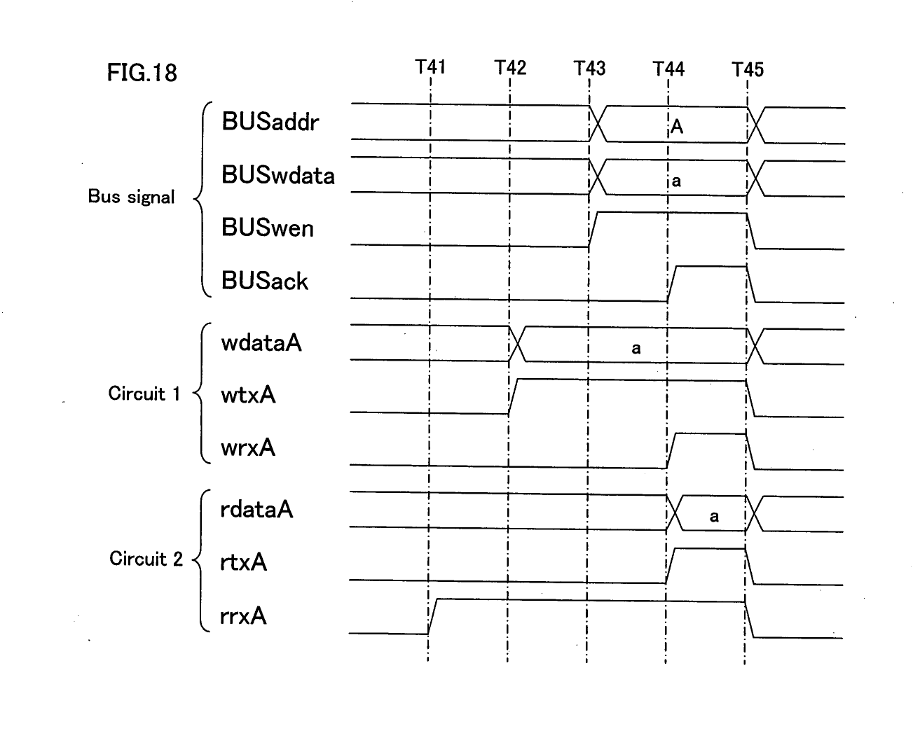

FIG. 19 is a block diagram showing an example of a basic structure of a conventional bus communication system in which a circuit executing the Receive command is a master circuit.

FIG. 20 is a timing diagram showing an example of a communication method such that, in the bus communication system of FIG. 19, the synchronizing data sender circuit is ready earlier than a circuit of the sender, and the Send command is executed earlier than the Receive command.

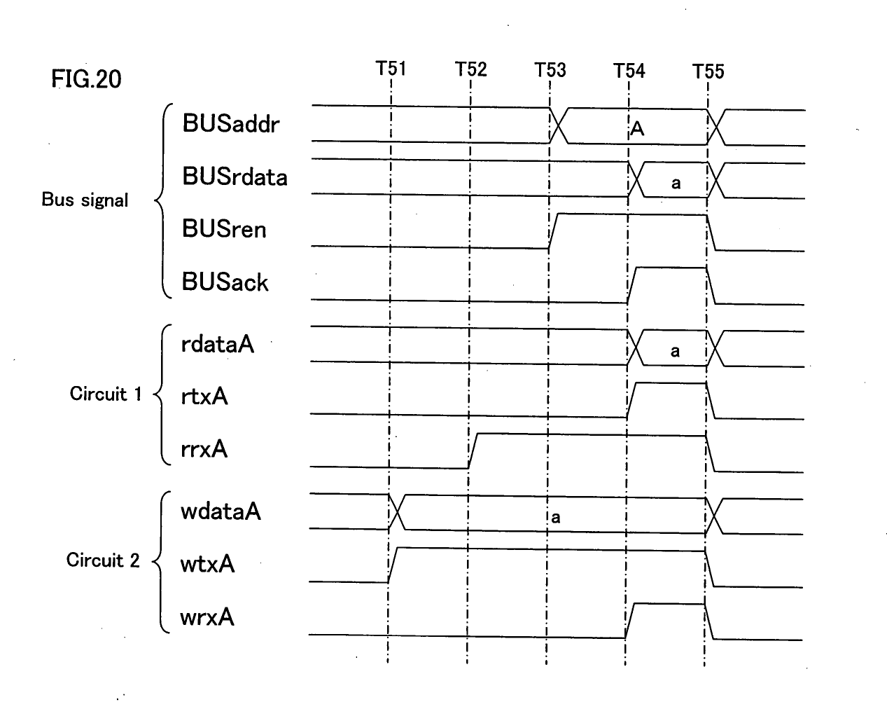

FIG. 21 is a timing diagram showing an example of a communication method such that, in the bus communication system of FIG. 19, the synchronizing data receiver circuit is ready earlier than the sender circuit, and the Receive command is executed earlier than the Send command.

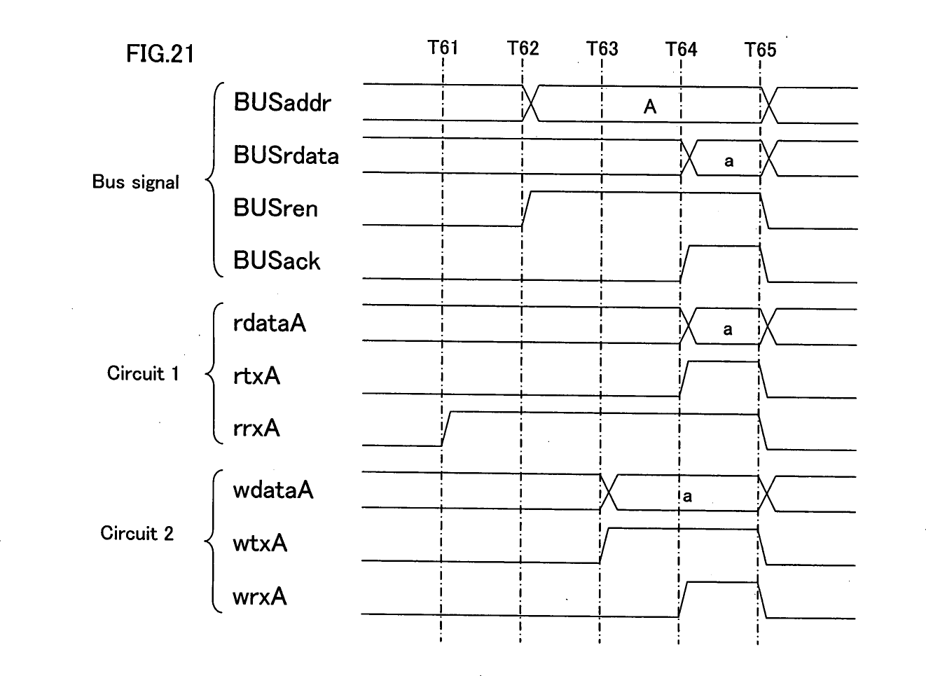

FIG. 22 is a block diagram for explaining a problem with conventional bus communication systems.

### DESCRIPTION OF THE PREFERRED EMBODIMENTS

Hereinafter, the present invention will be described by way of illustrative examples with reference to the accompanying drawings.

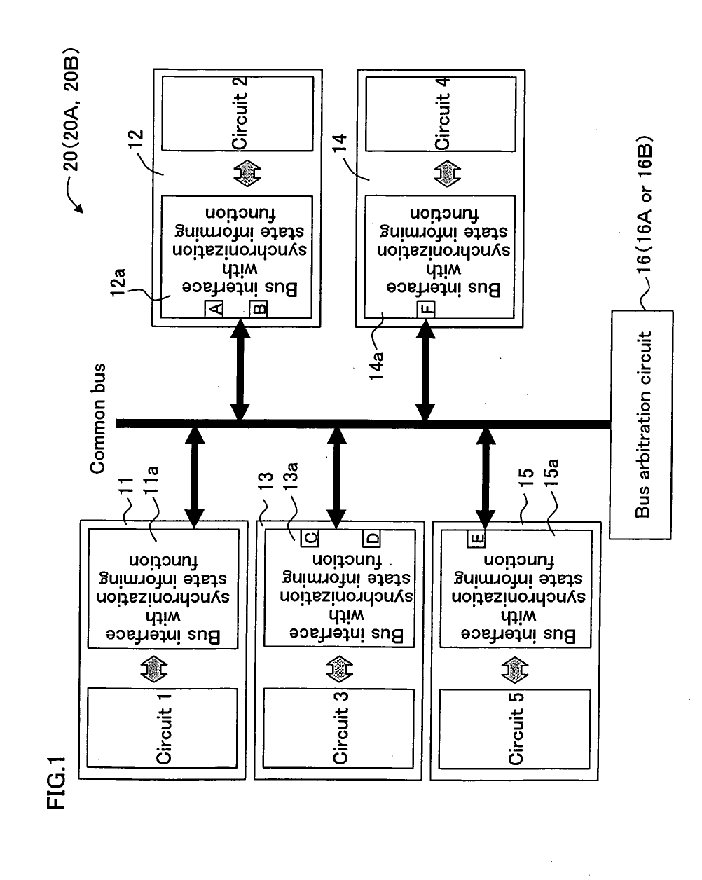

FIG. 1 is a block diagram showing a structure of a bus communication system according to an embodiment of the present invention.

Referring to FIG. 1, the bus communication system 20 of this embodiment comprises a plurality of circuits 11 to 15, which are connected via a common bus, and a bus arbitration circuit 16 connected to the common bus.

The circuits 11 to 15 are provided with circuits 1 to 5, respectively. Each of the circuits 1 to 5 is composed of an operator, such as adder, a multiplier or the like, a comparator or the like, and performs a process in accordance with a predetermined procedure. The circuits 11 to 15 are further provided with bus interfaces 11a to 15a, respectively. The bus interfaces 11a to 15a are provided to connect the circuits 1 to 5 to the common bus, with which communication is performed, and control data write/read operations in accordance with a bus protocol. In this case, an interface which sends a write/read request to the common bus is referred to as a master interface, while an interface which responds to a write/read request from the common bus is referred to as a slave interface. Also in the system, a circuit having a master interface is referred to as a master circuit, while a circuit having a slave interface is referred to as a slave circuit. Although a number of master circuits and slave circuits are actually connected via the common bus, only one master circuit 11 and four slave circuits 12 to 15 are shown in FIG. 1 for the sake of brevity.

In the bus communication system 20, one master circuit occupies the bus for a predetermined period of time to perform data transfer between the master circuit and the slave circuits. The bus arbitration circuit 16 permits bus transfer for one master circuit. When a plurality of master circuits request use of a bus simultaneously, the bus arbitration circuit 16 determines to which master circuit the right to occupy the bus is given.

Also in FIG. 1, letters A, B, C, D, E and F indicate synchronization ports for synchronized communication. The synchronization port actually means an address which is assigned to an address space of the common bus. The synchronization port is used by a master circuit to designate a communication destination, and therefore, is assigned to a bus interface of a slave circuit.

A circuit 11 shown in FIG. 1 is a master circuit, while circuits 12 to 15 are slave circuits. In the slave circuit 12, addresses A and B are assigned to a slave interface (bus interface) 12a. In the slave circuit 13, addresses C and D are assigned to a slave interface 13a. In the slave circuit 14, an address F is assigned to a slave interface 14a. In the slave circuit 15, an address E is assigned to a slave interface 15a.

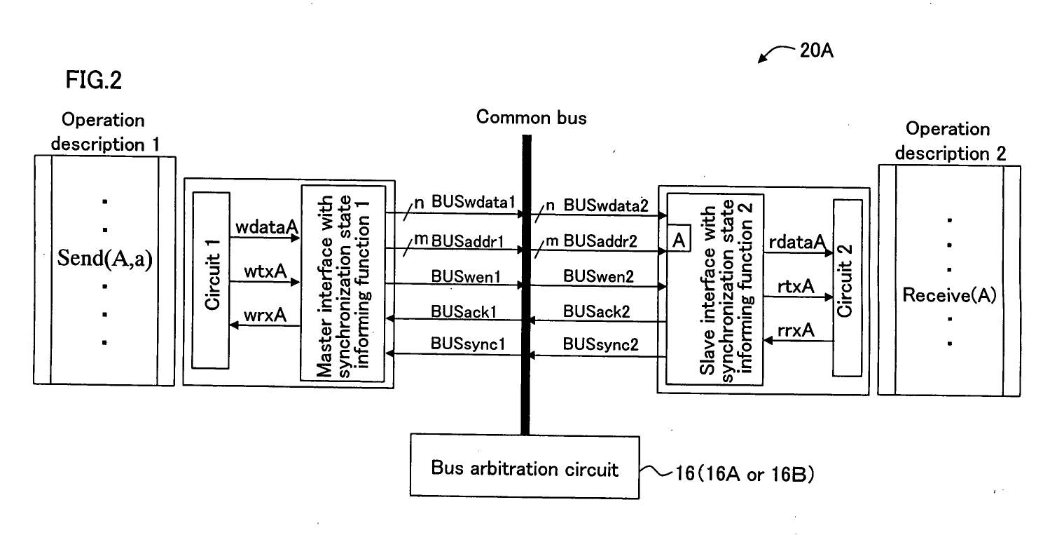

FIG. 2 is a block diagram showing an example of a basic structure of a bus communication system in which a circuit executing the Send command is a master circuit.

Referring to FIG. 2, an operation description 1 describes an operation of the circuit 1 such that Send(A, a) is executed in the circuit 1. An operation description 2 describes an operation of a circuit 2 such that Receive(A) is executed in the circuit 2. A wdataA signal and an rdataA signal are communication data signals. A wtxA signal and an rtxA signal are signals which indicate that the Send command has been executed, when the signal is HIGH (hereinafter referred to as Send command execution signals). A wrxA signal and an rrxA signal are signals which indicate that the Receive command has been executed, when the signal is HIGH (hereinafter referred to as Receive command execution signal).

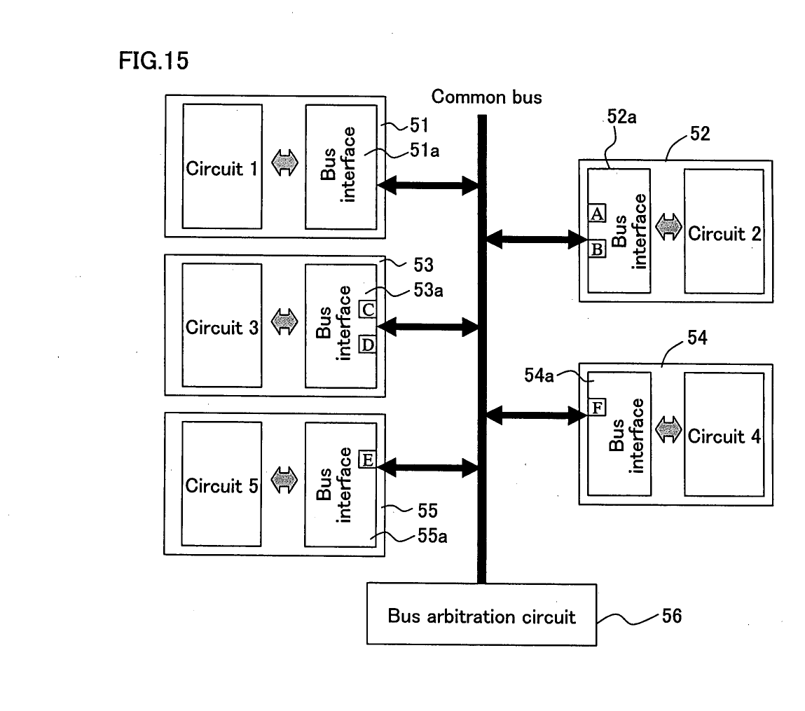

A common bus signal is composed of the BUSaddr signal, the BUSwdata signal, the BUSwen signal, and the BUSack signal of FIG. 15, and in addition, a BUSsync signal. The BUSaddr signal is a signal for designating an address. The BUSwdata signal is a write data signal. The BUSwen signal is a write request signal which indicates that a write request is output, when the signal is HIGH. The BUSack signal is a communication end signal which indicates that bus transfer is ended, when the signal is HIGH. The BUSsync signal is a synchronized communication transfer completion signal which indicates that data transfer in synchronized communication is completed, when the signal is HIGH. The BUSsync signal may be included in the BUSren signal.

In the bus communication system 20A of FIG. 2, a BUSwdata1 signal and a BUSwdata2 signal are included in the BUSwdata signal on the common bus. A BUSaddr1 signal and a BUSaddr2 signal are included in the BUSaddr signal on the common bus. A BUSwen1 signal and a BUSwen2 signal are included in the BUSwen signal on the common bus. A BUSack1 signal and a BUSack2 signal are included in the BUSack signal on the common bus. A BUSsync1 signal and a BUSsync2 signal are included in the BUSsync signal on the common bus.

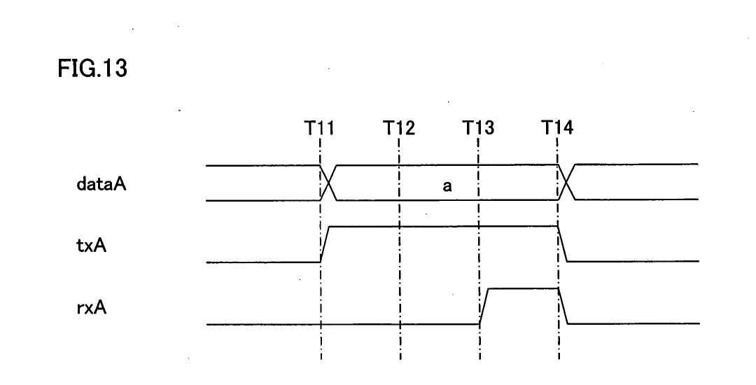

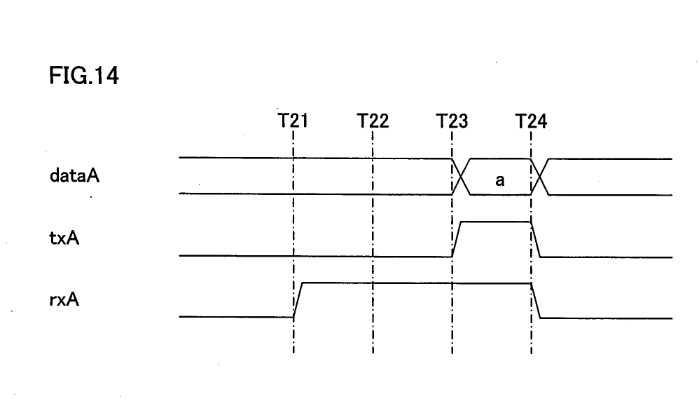

Hereinafter, an operation of the interface section will be described, where the method of FIGS. 13 and 14 is used for communication between the circuit 1 and a master interface 1 and communication between the circuit 2 and a slave interface 2 of FIG. 2. Here, as an example, it is assumed that if a slave circuit is not ready to receive data when a write request is issued from a master circuit, the number of cycles required until bus transfer is ended is zero (i.e., bus transfer is immediately ended).

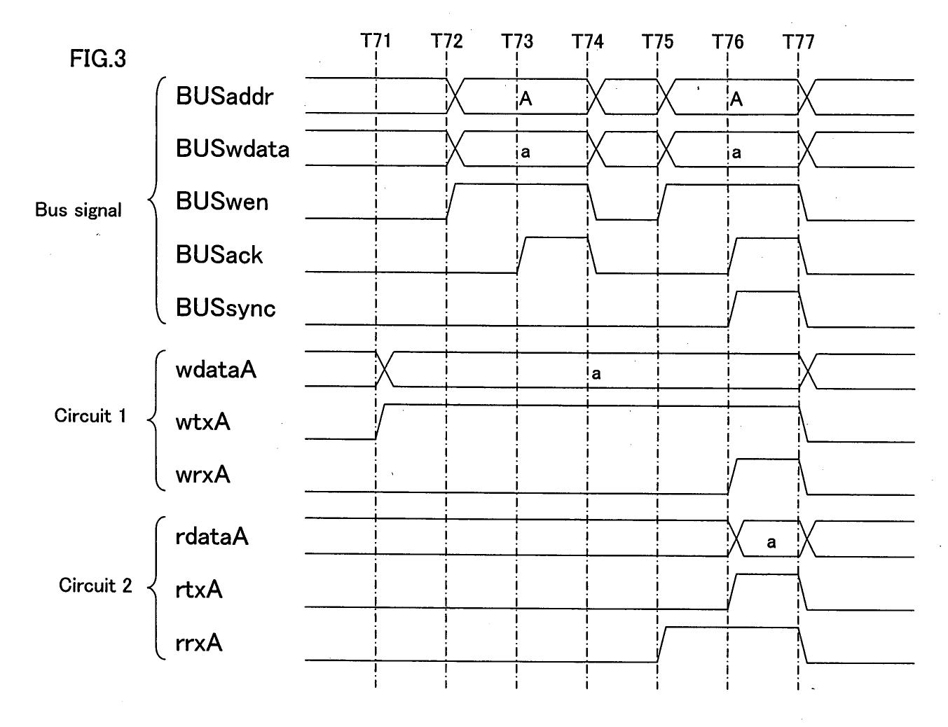

FIG. 3 is a timing diagram showing an example of a bus communication method of this embodiment such that, in the bus communication system 20A of FIG. 2, the synchronizing data sender circuit is ready earlier than the receiver circuit, and the Send command is executed earlier than the Receive command. Note that the initial values of the BUSwen signal, the BUSack signal, the BUSsync signal, the wtxA signal, the wrxA signal, the rtxA signal, and the rrxA signal are at a LOW level after being reset.

Referring to FIG. 3, when the circuit 1 causes the wtxA signal (Send command execution signal) to go to HIGH at T71, the master interface 1 determines which synchronization port is requested. At T72, the master interface 1 sends an address A and data a, which are included in the BUSaddr signal (address designation signal) and the BUSwdata signal (write data signal), respectively, on the common bus, and causes the BUSwen signal (write request signal) to go to HIGH, and waits until the BUSack signal (communication end signal) goes to HIGH.

When determining that a write request to the address A is present, at T73 the slave interface 2 immediately causes the BUSack signal (communication end signal) to go to HIGH during only one cycle, and ends the bus communication process. At the same time, the slave interface 2 sends a state of the rrxA signal (Receive command execution signal), which is included in the BUSsync signal (synchronized communication completion signal). In this case, the rrxA signal (Receive command execution signal) is LOW, indicating that the circuit 2 is not ready to receive a signal.

When the BUSack signal (communication end signal) goes to HIGH at T73, the master interface 1 sends a state of the BUSsync signal (synchronized communication completion signal), which is included in the wrxA signal (Receive command execution signal). In this case, the rrxA signal (Receive command execution signal) is LOW, so that the BUSsync signal is also LOW. Therefore, the wrxA signal (Receive command execution signal) is caused to go to LOW. In addition, the master interface 1 determines that the data destination is not yet ready to receive a signal, and performs a write operation again at T75. Specifically, similar to the case of T72, at T75 the master interface 1 sends the address A and the data a, which are included in the BUSaddr signal (address designation signal) and the BUSwdata signal (write data signal) on the common bus, and causes the BUSwen signal (write request signal) to go to HIGH and performs a write operation, and waits until the BUSack signal (communication end signal) goes to HIGH.

When determining that the write request to the address A is present, at T76 the slave interface 2 immediately causes the BUSack signal (communication end signal) to be HIGH during only one cycle, and completes the bus communication process. At the same time, the slave interface 2 sends the state of the rrxA signal (Receive command execution signal), which is included in the BUSsync signal. In this case, the rrxA signal (Receive command execution signal) is HIGH from T75, which means that data reception is completed. Further, the slave interface 2 sends the data a of the BUSwdata signal, which is included in the rdataA signal, and causes the rtxA signal (Send command execution signal) to be HIGH during one cycle.

When the BUSack signal (communication end signal) goes to HIGH at T76, the master interface 1 determines the state of the BUSsync signal (synchronized communication completion signal) at T77. In this case, the BUSsync signal (synchronized communication completion signal) is HIGH, and therefore, the master interface 1 determines that the data destination has received the data, and ends the write operation. Further, the master interface 1 sends the state of the BUSsync signal (synchronized communication completion signal), which is included in the wrxA signal (Receive command execution signal), during from T76 to T77, in which the BUSack signal (communication end signal) is HIGH. In this case, since the BUSsync signal (synchronized communication completion signal) is HIGH, the wrxA signal (Receive command execution signal) is caused to go to HIGH. At T77, the synchronized communication is completed.

Here, it is assumed that a conventional bus communication system is used. The BUSack signal (communication end signal) is still LOW at T73. The BUSack signal (communication end signal) goes to HIGH at T76. Therefore, the common bus is occupied during from T73 to T76. During this period of time, the other master circuits cannot use the common bus.

In contrast, according to this embodiment, the bus is temporarily released at T74, and the right to occupy the bus can be given to another master circuit. Therefore, the bus can be effectively utilized without occurrence of deadlock.

In order to effectively utilize the bus without occurrence of deadlock, the bus arbitration circuit 16 is provided with a function of avoiding a master circuit accessing the same address from being continuously given the right to occupy the bus.

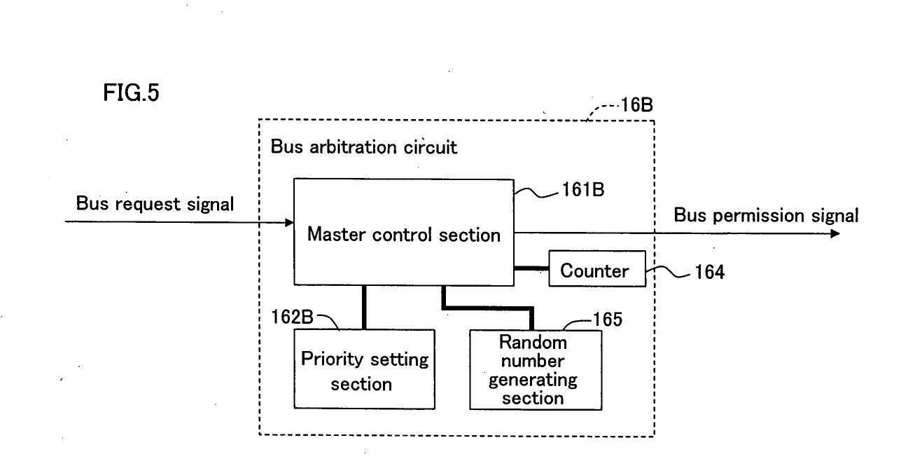

For example, typically, master circuits are successively given the right to occupy in order of predetermined priority (highest first). When a plurality of master circuits issue a bus request, the priority of a master circuit which has been given the right to occupy the bus a predetermined of times may be temporarily lowered so that master circuits can be successively given the right to occupy the bus. Alternatively, master circuits may be given the right to occupy the bus at random (FIG. 5), for example.

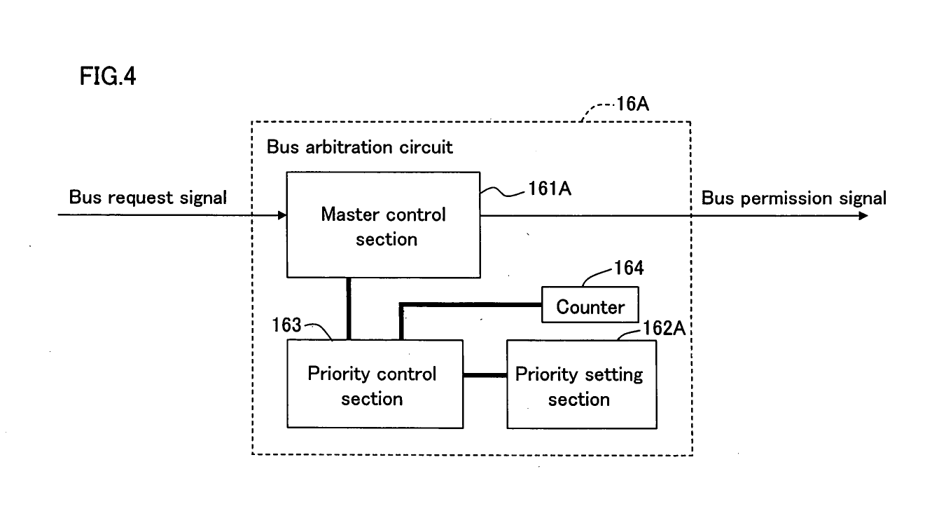

FIG. 4 is a block diagram showing an exemplary structure of an arbitration circuit bus which is the same as the arbitration circuit 16 of FIG. 1, except that the arbitration circuit bus of FIG. 4 employs the method of temporarily lowering the right to occupy the bus.

Referring to FIG. 4, the bus arbitration circuit 16A comprises a master control section 161A, a priority setting section 162A, a priority control section 163, and a counter 164.

The master control section 161A determines the presence or absence of a bus request (data transfer request). If the bus request is issued, the master control section 161A outputs a bus permission signal so as to give the right to occupy the bus to a master circuit having a high priority assigned by the priority control section 163.

The priority setting section 162A sets the priorities of the master circuits in the bus communication system 20.

The priority control section 163 is connected to the counter 164 to supervise which master circuit is given the right to occupy. The number of times of the right to occupy being continuously given to the same master circuit is counted using the counter 164. When the count value reaches a predetermined number of times, the priority of the master circuit which is currently given the right to occupy is lowered to the lowest priority.

FIG. 5 is a block diagram showing an exemplary structure of a bus arbitration circuit which is the same as the bus arbitration circuit 16 of FIG. 1, except that the bus arbitration circuit of FIG. 5 employs a method of giving the right to occupy the bus to a master circuit at random.

Referring to FIG. 5, the bus arbitration circuit 16B comprises a master control section 161B, a priority setting section 162B, a counter 164, and a random number generating section 165.

The master control section 161B determines the presence or absence of a bus request (data transfer request) from a master circuit. If the bus request is issued, the master control section 161B outputs a bus permission signal to give the right to occupy the bus to a master circuit having a high priority assigned by the priority setting section 162B. Further, the master control section 161B is connected to the counter 164 to supervise which master circuit is given the right to occupy. The number of times of the right to occupy being continuously given to the same master circuit is counted using the counter 164. When the count value reaches a predetermined number of times, a bus permission signal is output to give a master circuit the right to occupy the bus at random irrespective of the priority using the random number generating section 165.

The priority setting section 162B sets the priorities of the master circuits in the bus communication system 20.

The random number generating section 165 generates a random number within the number of the master circuits which perform synchronized communication in the bus communication system 20.

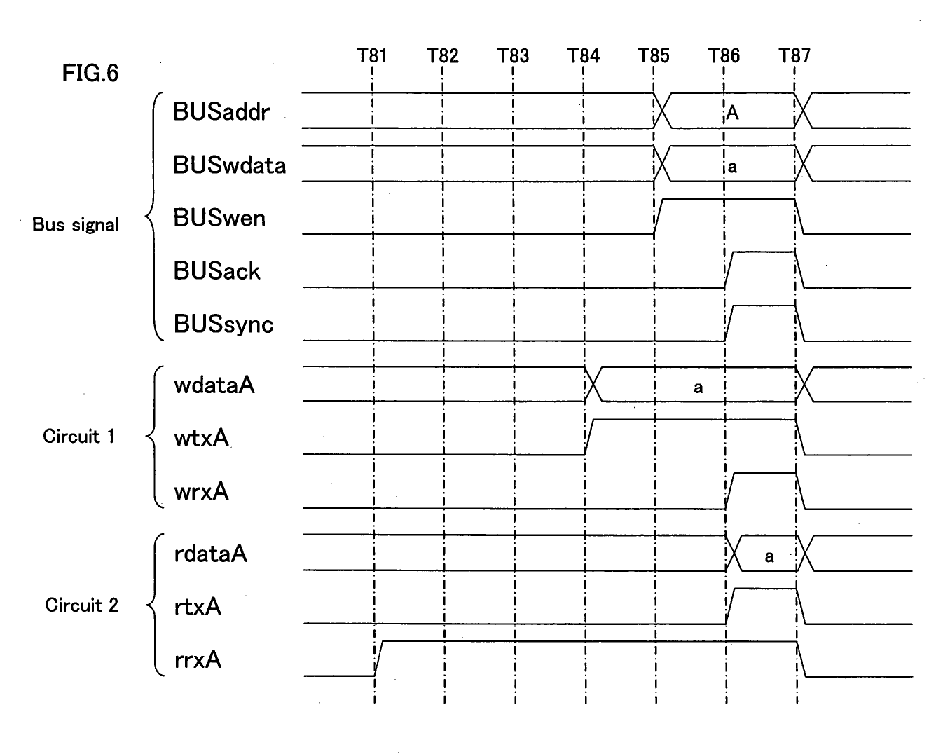

FIG. 6 is a timing diagram showing an example of a communication method such that, in the bus communication system 20A of FIG. 2, a synchronizing data receiver circuit is ready earlier than the sender circuit, and the Receive command is executed earlier than the Send command. Note that the initial values of the BUSwen signal, the BUSack signal, the BUSsync signal, the wtxA signal, the wrxA signal, the rtxA signal, and the rrxA signal are at a LOW level after being reset.

Referring to FIG. 6, when the circuit 2 causes the rrxA signal (Receive command execution signal) to go to HIGH at T81, the slave interface 2 waits until a write request to an address A is issued.

Next, when the circuit 1 causes the wtxA signal (Send command execution signal) to go to HIGH at T84, the master interface 1 determines which synchronization port is requested.

Further, at T85, the master interface 1 sends an address A and data a, which are included in the BUSaddr signal and the BUSwdata signal, respectively, on the common bus, and causes the BUSwen signal (write request signal) to go to HIGH, and waits until the BUSack signal (communication end signal) goes to HIGH.

When determining that the write request to the address A is present, at T86 the slave interface 2 immediately causes the BUSack signal (communication end signal) to be HIGH during one cycle. At the same time, the slave interface 2 sends a state of the rrxA signal (Receive command execution signal) to the BUSsync signal (synchronized communication completion signal). In this case, the rrxA signal (Receive command execution signal) is HIGH, which means that data reception is completed. Further, the slave interface 2 sends data a of the BUSwdata signal, which is included in the rdataA signal, and causes the rtxA signal (Send command execution signal) to be HIGH during one cycle.

When the BUSack signal (communication end signal) goes to HIGH at T86, the master interface 1 sends a state of the BUSsync signal (synchronized communication completion signal), which is included in the wrxA signal (Receive command execution signal). In this case, the BUSsync signal (synchronized communication completion signal) is HIGH, and therefore, the master interface 1 causes the wrxA signal (Receive command execution signal) to go to HIGH. The master interface 1 determines the state of the BUSsync signal (synchronized communication completion signal). Since the BUSsync signal (synchronized communication completion signal) is HIGH, the master interface 1 determines that the data desitination has received the data, and ends the write operation. At T87, the synchronized communication is completed.

In the above-described examples of FIGS. 3 and 6, a master circuit may not immediately obtain the right to occupy the bus. Even in this case, by causing the wrxA signal to be LOW until obtaining the right to occupy the bus, synchronized communication can be similarly achieved.

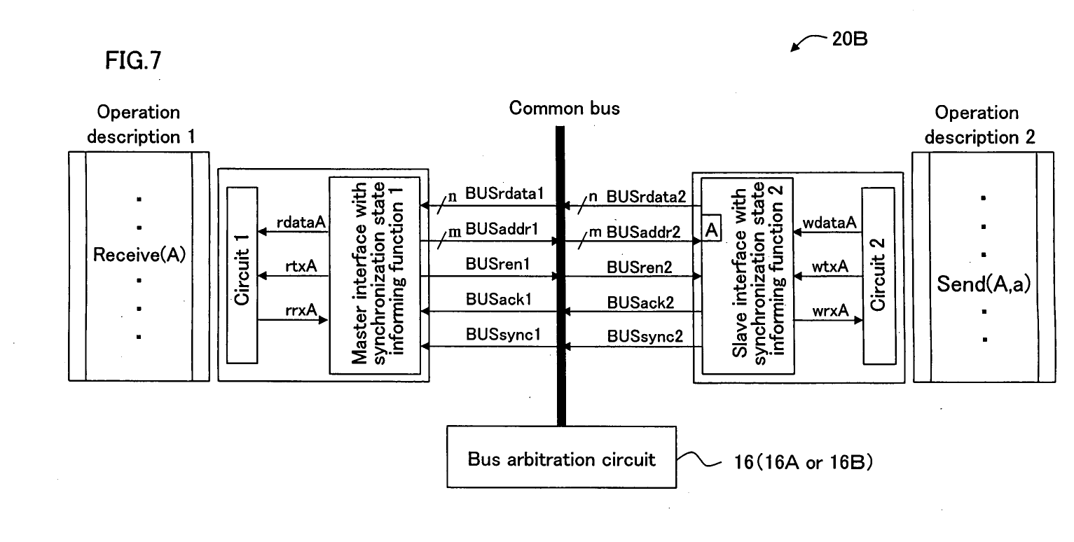

FIG. 7 is a block diagram showing a basic structure of a bus communication system which is the same as the bus communication system of FIG. 1, except that a circuit executing the Receive command is a master circuit.

Referring to FIG. 7, an operation description 1 describes an operation of a circuit 1 such that the circuit 1 executes Receive(A). An operation description 2 describes an operation of a circuit 2 such that the circuit 2 executes Send(A, a). A wdataA signal and an rdataA signal are communication data signals. A wtxA signal and an rtxA signal are signals (hereinafter referred to as a Send command execution signal) which indicate that the Send command has been executed, when the signal is HIGH. A wrxA signal and an rrxA signal are signals (referred to as a Receive command execution signal) which indicate that the Receive command has been executed, when the signal is HIGH.

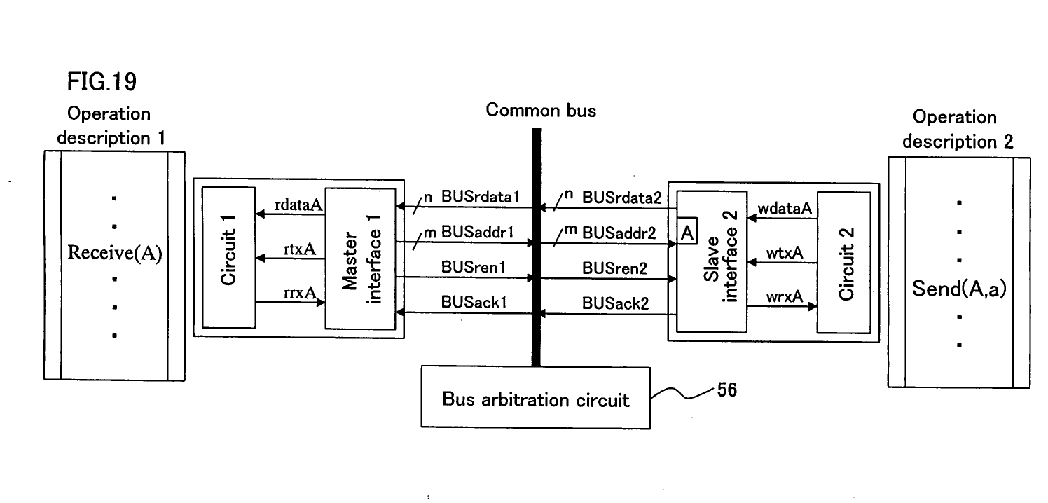

A common bus signal is composed of the BUSaddr signal, the BUSrdata signal, the BUSren signal, and the BUSack signal of FIG. 19, and in addition, a BUSsync signal. The BUSaddr signal is a signal for designating an address (hereinafter referred to as an address desinating signal). The BUSrdata signal is a read data signal. The BUSren signal is a read request signal which indicates that a read request is output, when the signal is HIGH. The BUSack signal is a communication end signal which indicates that bus transfer is ended, when the signal is HIGH. The BUSsync signal is a synchronized communication transfer completion signal which indicates that data transfer in synchronized communication is completed, when the signal is HIGH. The BUSsync signal may be included in the BUSren signal.

In the bus communication system 20B of FIG. 7, a BUSrdata1 signal and a BUSrdata2 signal are included in the BUSrdata signal on the common bus. A BUSaddr1 signal and a BUSaddr2 signal are included in the BUSaddr signal on the common bus. A BUSren1 signal and a BUSren2 signal are included in the BUSren signal on the common bus. A BUSack1 signal and a BUSack2 signal are included in the BUSack signal on the common bus. A BUSsync1 signal and a BUSsync2 signal are included in the BUSsync signal on the common bus.

Hereinafter, an operation of the interface section will be described, where the method of FIG. 13 is used for communication between the circuit 1 and a master interface 1 and the method of FIG. 14 is used for communication between communication between the circuit 2 and a slave interface 2. Here, as an example, it is assumed that if a slave circuit is not ready to receive data when a write request is issued from a master circuit, the number of cycles required until bus transfer is ended is zero (i.e., bus transfer is immediately ended).

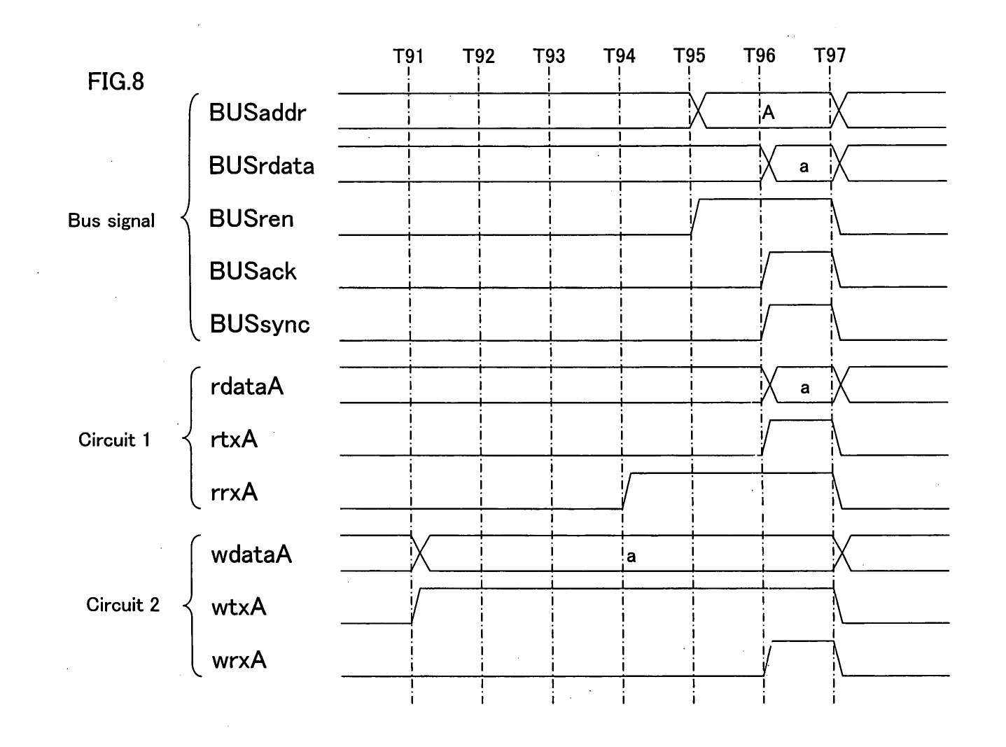

FIG. 8 is a timing diagram showing an example of a bus communication method such that, in the bus communication system 20B of FIG. 7, the synchronizing data sender circuit is ready earlier than the receiver circuit, and the Send command is executed earlier than the Receive command. Note that the initial values of the BUSren signal, the BUSack signal, the BUSsync signal, the wtxA signal, the wrxA signal, the rtxA signal, and the rrxA signal are at a LOW level after being reset.

Referring to FIG. 8, when the circuit 2 causes the wtxA signal (Send command execution signal) to go to HIGH at T91, the slave interface 2 waits until a write request to an address A is issued.

Next, when the circuit 1 causes the rrxA signal (Receive command execution signal) to go to HIGH at T94, the master interface 1 determines which synchronization port is requested. At T95, the master interface 1 sends the address A, which is included in the BUSaddr signal on the common bus, and causes the BUSren signal (read request signal) to go to HIGH, and waits until the BUSack signal (communication end signal) goes to HIGH.

When determining that the read request to the address A is present, at T96 the slave interface 2 causes the BUSack signal (communication end signal) to be HIGH during only one cycle and sends data a of the BUSwdata signal, which is included in the BUSrdata signal in order to immediately end the bus communication process. At the same time, the slave interface 2 sends a state of the wtxA signal (Send command execution signal), which is included in the BUSsync signal (synchronized communication completion signal). In this case, the wtxA signal (Send command execution signal) is HIGH, which means that data send is completed. Further, the slave interface 2 causes the wrxA signal (Receive command execution signal) to be HIGH during one cycle.

When the BUSack signal (communication end signal) goes to HIGH at T96, the master interface 1 sends a state of the BUSsync signal (synchronized communication completion signal), which is included in the rtxA signal (Send command execution signal). In this case, the BUSsync signal (synchronized communication completion signal) is HIGH, and therefore, the master interface 1 causes the rtxA signal (Send command execution signal) to go to HIGH. Further, the master interface 1 sends the data a of the BUSrdata signal, which is included in the BUSrdata signal, and determines the state of the BUSsync signal (synchronized communication completion signal). Since the BUSsync signal (synchronized communication completion signal) is HIGH, the read operation is ended. At T97, the synchronized communication is completed.

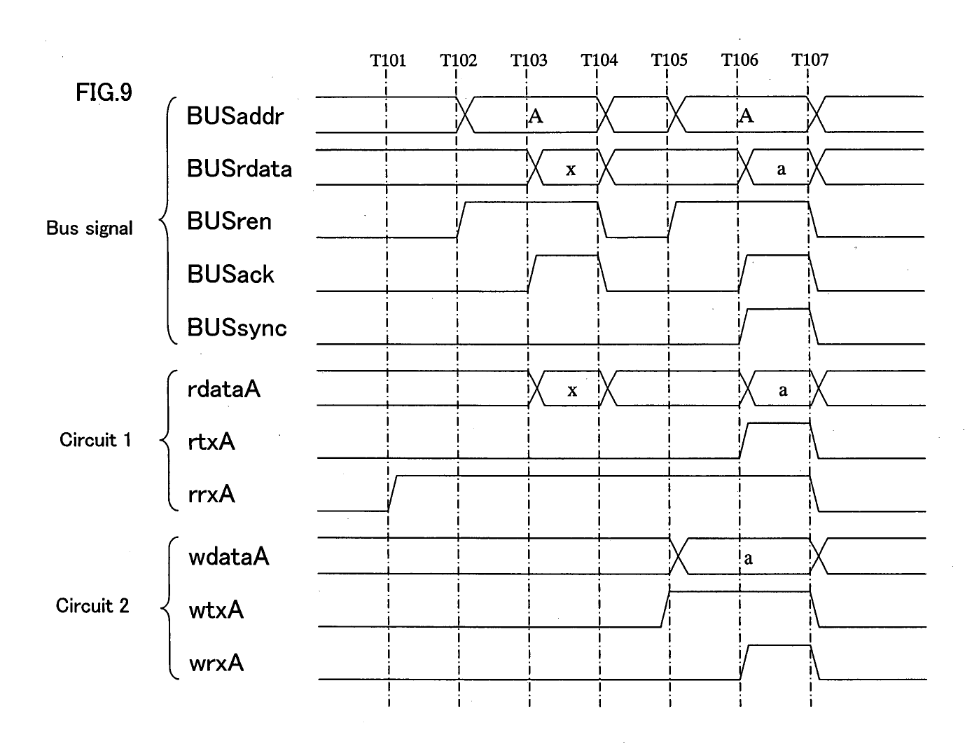

FIG. 9 is a timing diagram showing an example of a communication method such that, in the bus communication system 20B of FIG. 7, a synchronizing data receiver circuit is ready earlier than the sender circuit, and the Receive command is executed earlier than the Send command. Note that the initial values of the BUSren signal, the BUSack signal, the BUSsync signal, the wtxA signal, the wrxA signal, the rtxA signal, and the rrxA signal are at a LOW level after being reset.

Referring to FIG. 9, when the circuit 1 causes the rrxA signal (Receive command execution signal) to go to HIGH at T101, the master interface 1 determines which synchronization port is requested. At T102, the master interface 1 sends the address A, which is included in the BUSaddr signal on the common bus, and causes the BUSren signal (read request signal) to go to HIGH, and waits until the BUSack signal (communication end signal) goes to HIGH.

When determining that the read request to the address A is present, at T103 the slave interface 2 immediately causes the BUSack signal (communication end signal) to be HIGH during only one cycle to end the bus communication process. At the same time, the slave interface 2 sends the state of the wtxA signal (Send command execution signal), which is included in the BUSsync signal (synchronized communication completion signal). In this case, the wtxA signal (Send command execution signal) is LOW, which means that read data is not yet ready.

When the BUSack signal (communication end signal) goes to HIGH at T103, the master interface 1 sends a state of the BUSsync signal (synchronized communication completion signal), which is included in the rtxA signal (Send command execution signal). In this case, the BUSsync signal (synchronized communication completion signal) is LOW, and therefore, the master interface 1 causes the rtxA signal (Send command execution signal) to go to LOW. Further, the master interface 1 determines that data read is not yet ready, and performs a read operation again at T105. Specifically, at T105 the master interface 1 sends the address A, which is included in the BUSaddr signal on the common bus, causes the BUSren signal (read request signal) to go to HIGH and performs a read operation, and waits until the BUSack signal (communication end signal) goes to HIGH.

When determining that the read request to the address A is present, at T106 the slave interface 2 causes the BUSack signal (communication end signal) to go to HIGH during one cycle, and sends a data a of the BUSwdata signal, which is included in the BUSrdata signal, in order to end the bus communication process. At the same time, the slave interface 2 sends a state of the wtxA signal (Send command execution signal), which is included in the BUSsync signal (synchronized communication completion signal). In this case, the wtxA signal (Send command execution signal) is HIGH, which means that data send is completed. Further, the slave interface 2 causes the wrxA signal (Receive command execution signal) to be HIGH during one cycle.

When the BUSack signal (image end signal) goes to HIGH at T106, the master interface 1 sends the state of the BUSsync signal (synchronized communication completion signal), which is included in the rtxA signal (Send command execution signal). In this case, the BUSsync signal (synchronized communication completion signal) is HIGH, and therefore, the master interface 1 causes the rtxA signal (Send command execution signal) to go to HIGH. Further, the master interface 1 sends the data a of the BUSrdata signal, which is included in the BUSrdata signal, and determines the state of the BUSsync signal (synchronized communication completion signal). Since the BUSsync signal (synchronized communication completion signal) is HIGH, the read operation is ended. At T107, the synchronized communication is completed.

In the examples of FIGS. 7 and 9, a master circuit may not immediately obtain the right to occupy the bus. Even in this case, by causing the rtxA signal to be LOW until obtaining the right to occupy the bus, synchronized communication can be similarly achieved.

In the foregoing description, one circuit has one of a master interface and a slave interface. Alternatively, one circuit can have both a master interface and a slave interface.

In synchronized communication between one master circuit and a plurality of synchronization ports, read requests or write requests to a plurality of synchronization ports simultaneously occurs in slave interfaces. In this case, it is preferable that, by providing an internal arbitration circuit in the master interface, access to the same synchronization port is continued not more than a predetermined number of times.

For example, typically, data transfers are successively executed in order of predetermined priority (highest first). When a plurality of data transfer requests are issued, the priority of a data transfer which has been executed a predetermined number of times may be temporarily lowered so that the sequence of synchronization ports to be accessed is changed, or data transfers may be executed at random.

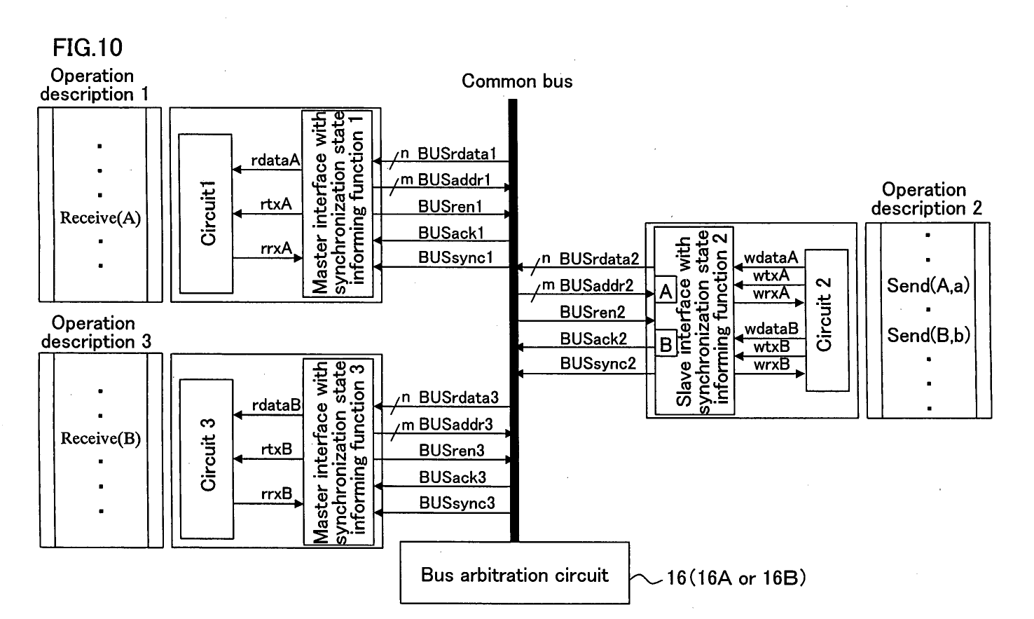

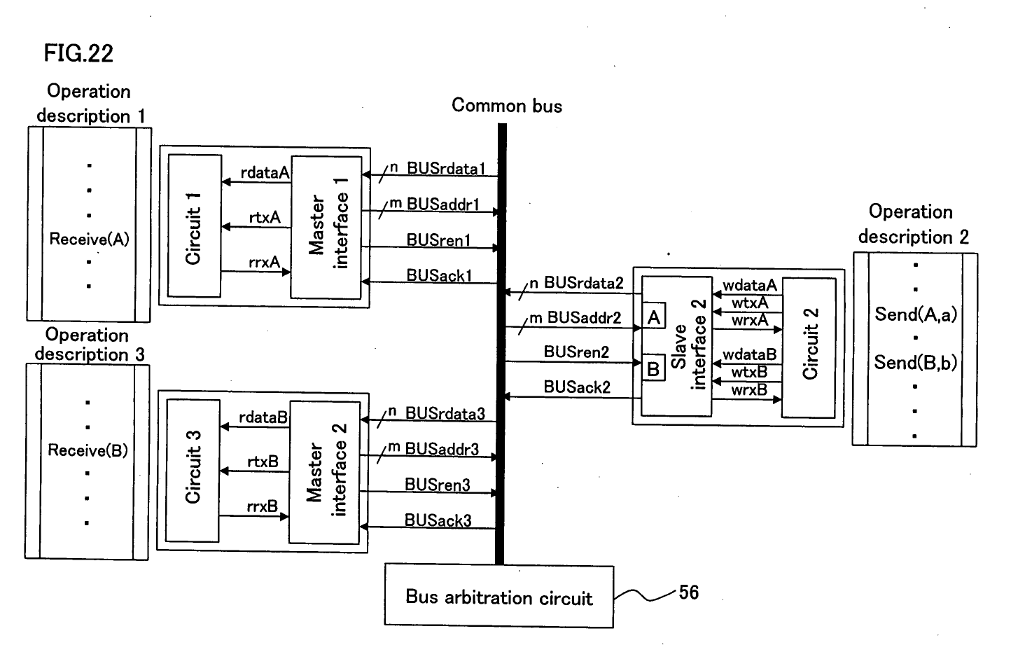

FIG. 10 is a block diagram showing a system structure to which a bus communication system of the present invention is applied with respect to the conventional bus communication system structure of FIG. 22 having the problem.

In FIG. 10, an example of a communication method will be described where the receiver is a master circuit. Referring to FIG. 10, in the bus communication system, a circuit 1 executes a Receive(A) command, a circuit 3 executes a Receive(B) command, and a circuit 2 executes a Send(A, a) command, and thereafter, executes a Send(B, b) command.

According to the bus communication system of the present invention, the Receive command of the circuit 3 may be executed earlier than the circuit 1, the bus arbitration circuit 16 may give a master interface 3 the right to occupy a bus, and a data read request may be issued to a synchronization port B. Even in this case, a slave interface 2 (read data destination) returns a response signal indicating that data sending is not ready, so that bus communication is temporarily stopped.

Meanwhile, a master interface 1 outputs a read request to a synchronization port A and the arbitration circuit 16 gives the master interface 1 the right to occupy. If the slave interface 2 is waiting for the read request to the synchronization port A, synchronized communication via the synchronization port A is established, and thereafter, synchronized communication via the synchronization port B can be established. Therefore, deadlock does not occur.

According to the above-described embodiment of the present invention, when receiving a data transfer request from the master circuit 1, the slave interface 2 immediately informs the slave interface 1 of the end of bus transfer and the completion of data transfer if data transfer is permitted. If data transfer is not permitted, the slave interface 2 waits for a predetermined number of cycles. Thereafter, if data transfer is still not permitted, the slave interface 2 immediately informs the slave interface 1 of the end of bus transfer and no permission of data transfer. If data transfer is permitted during when waiting, the slave interface 2 immediately informs the slave interface 1 of the end of bus transfer and the completion of data transfer. In this case, the bus arbitration circuit 16 performs arbitration in a manner which gives the right to occupy the bus to a master circuit which sends a data request to the same address, not more than a predetermined number of times continuously, when a plurality of master circuits send a transfer request. As a result, by using a common bus, the amount of wiring between circuits can be reduced and deadlock which otherwise occurs in conventional technology can be prevented, thereby making it possible to perform synchronized communication more efficiently.

The present invention is directed to a bus communication system in which data transfer is performed among a plurality of circuits via a bus in synchronized communication. According to the present invention, a common bus is provided between circuits performing synchronized communication so that the amount of wiring between circuits can be reduced and the common bus is occupied only as required. The common bus is not continuously occupied, thereby making it possible to achieve a bus communication system capable of efficient synchronized communication. The present invention can be applied to a wide range of large scale integrated circuits which perform synchronized communication among a plurality of circuits.

Although certain preferred embodiments have been described herein, it is not intended that such embodiments be construed as limitations on the scope of the invention except as set forth in the appended claims. Various other modifications and equivalents will be apparent to and can be readily made by those skilled in the art, after reading the description herein, without departing from the scope and spirit of this invention. All patents, published patent applications and publications cited herein are incorporated by reference as if set forth fully herein.

1. A bus communication system for enabling data transfer in synchronized communication, comprising:
a plurality of master circuits;
a slave circuit connected to the plurality of master circuits;
a bus connected to the plurality of master circuits and the slave circuit; and
a bus arbitration circuit connected to the bus,
wherein data transfer is performed between the plurality of master circuits and the slave circuit via the bus,
the bus arbitration circuit performs arbitration such that, when a transfer request is output from the plurality of master circuits, a right to occupy the bus is given to the master circuit which continuously outputs the transfer request to the same address, not more than a predetermined number of times continuously,
when receiving the transfer request from the master circuit, the slave circuit informs the master circuit of the end of bus transfer and whether or not data transfer is ready, and
when informed that data transfer is ready, the master circuit ends data transfer, and when informed that data transfer is not ready, the master circuit outputs a transfer request to the slave circuit again.

2. A bus communication system according to claim 1, wherein when the slave circuit receives the transfer request from the master circuit and informs the master circuit that data transfer is not ready, the slave circuit informs the master circuit of the end of bus transfer after waiting for a predetermined number of cycles if data transfer is still not ready, or immediately informs the master circuit of the end of bus transfer and informs that data transfer is ready if data transfer gets ready partway during waiting.

3. A bus communication system according to claim 1, wherein when data is written from the master circuit to the slave circuit, the write data is sent from the master circuit and the write data is received by the slave circuit,
in the data transfer operation, when the slave circuit receives a data write request as the transfer request from the master circuit, the slave circuit informs the master circuit of the end of bus transfer and whether or not data write is ready, and
when informed by the slave circuit that data write is ready, the master circuit ends the data write operation, or when informed by the slave circuit that data write is not ready, the master circuit outputs the data write request to the slave circuit again.

4. A bus communication system according to claim 1, wherein when the master circuit performs reading data from the slave circuit, the read data is sent from the slave circuit and the read data is received by the master circuit,
in the data transfer operation, when the slave circuit receives a data read request as the transfer request from the master circuit, the slave circuit informs the master circuit of the end of bus transfer and whether or not data read is ready, and
when informed by the slave circuit that data read is ready, the master circuit ends the data read operation, or when informed by the slave circuit that data read is not ready, the master circuit outputs the data read request to the slave circuit again.

5. A bus communication system according to claim 1, wherein when the plurality of master circuits output a transfer request, the bus arbitration circuit assigns priorities to the plurality of master circuits and gives:
the plurality of master circuits the right to occupy the bus in order of the priority, highest first, and
the bus arbitration circuit performs arbitration in a manner such that when the right to occupy the bus is given to the master circuit having a high priority which is accessing the same address, the predetermined number of times continuously, the priority of the master circuit continuously given the right to occupy the bus is temporarily lowered, and another master circuit is given the right to occupy the bus.

6. A bus communication system according to claim 1, wherein when the plurality of master circuits output a transfer request, the bus arbitration circuit assigns priorities to the plurality of master circuits and gives the plurality of master circuits the right to occupy the bus in order of the priority, highest first, and
the bus arbitration circuit performs arbitration in a manner such that when the right to occupy the bus is given to the master circuit having a high priority which is accessing the same address, the predetermined number of times continuously, the right to occupy the bus is given to the master circuit at random irrespective of the priorities.

7. A bus communication system according to claim 1, wherein the master circuit has an internal arbitration circuit, wherein the internal arbitration circuit performs arbitration in a manner such that when a plurality of data transfer requests to the bus are simultaneously issued, the same data transfer request is prevented from being continued more than the predetermined number of times.

8. A bus communication system according to claim 7, wherein when the plurality of master circuits output a transfer request, the internal arbitration circuit assigns priorities to the plurality of master circuits and gives the plurality of master circuits the right to occupy the bus in order of the priority, highest first, and
the internal arbitration circuit performs arbitration in a manner such that when the right to occupy the bus is given to the master circuit having a high priority which is accessing the same address, the predetermined number of times continuously, the priority of the master circuit continuously given the right to occupy the bus is temporarily lowered, and another master circuit is given the right to occupy the bus.

9. A bus communication system according to claim 7, wherein when the plurality of master circuits output a transfer request, the internal arbitration circuit assigns priorities to the plurality of master circuits and gives the plurality of master circuits the right to occupy the bus in order of the priority, highest first, and
the internal arbitration circuit performs arbitration in a manner such that when the right to occupy the bus is given to the master circuit having a high priority which is accessing the same address, the predetermined number of times continuously, the right to occupy the bus is given to the master circuits at random irrespective of the priorities.
